(19) United States
(12) Patent Application Publication
(10) Pub. No.: US 2004/0065524 A1
(43) Pub. Date: Apr. 8, 2004

(54) Parcel sortation system

(76) Inventors: Scott D. Flood, Cincinnati, OH (US); Fred R. Rombold, Florence, KY (US)

Correspondence Address: DINSMORE & SHOHL, LLP, 1900 CHEMED CENTER, 255 EAST FIFTH STREET, CINCINNATI, OH, 45202, US

(21) Appl. No.: 10/265,808

(22) Filed: Oct. 7, 2002

(51) Int. Cl. B65G 47/46

(52) U.S. Cl. 198/370.01

(57) ABSTRACT

The present invention relates generally to a parcel sortation system and is specifically disclosed in connection with a customizable scalable sorting system and method for sorting parcels. The sortation system and method for sorting parcels are include an induction station wherein data particular to the parcel regarding its desired parcel destination is received by a controller and communicated by the controller to the sortation system, as the parcel continues to a sorting station, where the parcel is sorted as instructed by the controller, and if not sorted then is collected at the end station, terminating the sorting of the parcel.

### TECHNICAL FIELD

The present invention relates generally to a parcel sortation system and is specifically disclosed in connection with a customizable scalable sorting system and method for sorting parcels.

### BACKGROUND OF THE INVENTION

Improvements in the delivery of parcels including, increased number of routes, shorter delivery times and greater flexibility in regards to the size and types of parcels that can be delivered, have helped to drive and promote an atmosphere where people rely on such advancements to carry on in both their personal and business environments. Such advancements have created expectations which have reshaped how the average consumer has come to rely on the delivery of parcels, whether it is sending a letter across town or a package half way across the world, these consumers count on the versatility now available in delivery systems.

One particular area of improvement in the delivery of parcels has been in the sorting of various parcels so that these parcels are accurately delivered to their desired destinations. For example, manual systems have been replaced by automated, computer monitored systems, leading to faster sorting machines having higher degrees of accuracy in regards to sending the parcels to the correct locations. However, with many of the benefits associated with the improved sorter systems, there have been additional costs. Mainly, the costs associated with purchasing and operating such machines. Because of the high costs associated with such sorter systems, generally only larger postal installations or delivery company depots have installed such machines, leaving the smaller markets to suffer with slower, outdated systems.

Currently, there does not exist a sorting system, which provides such benefits as high sort capacity and accuracy, that is financially and logistically feasible for the postal installations, and other delivery companies, operating in smaller markets that would also benefit from the use of such machines. The present invention provides a solution to this problem by introducing a parcel sortation system which utilizes these high-end benefits, but provides them in a low-cost, highly customizable system. The customization provided by the present invention, allows a user to vary the size of the sortation system depending on need or lack of space, but still takes advantage of technology used on larger sorting systems. Furthermore, the present invention reduces the necessary capital expenditures typically required to obtain such a sorting system, and provides lower operating costs, wherein the sorting system suffers less downtime, than the designs currently available on the market. It should therefore be noted, that although the present invention provides advantages to smaller markets, this sortation system could obviously be taken advantage of in larger facilities as well. It is also important to note that all of the benefits provided by this sortation system and the methods employed in carrying out the sorting process, provide solutions not previously known or appreciated in the art.

### SUMMARY OF THE INVENTION

According to one aspect of the present invention, a parcel sortation system is provided to bring a low-cost option to small markets, giving customers a high speed, accurate sorting system that allows for simple expansion.

According to another aspect of the present invention, a parcel sortation system is provided for sorting parcels of various sizes and shapes.

In accordance with another aspect of the present invention, a parcel sortation system is provided that allows for the customization of a sorting station, wherein the sorting station can be varied in length and overall design.

In yet another aspect of the present invention, the parcel sortation system includes modular interfaces that allow the sorting station to interconnect with other stations along the sortation system.

According to yet another aspect of the present invention, the parcel sortation system provides modular interfaces that are integrated with the sorting station which allow parcels to be sorted to their desired parcel destinations.

In accordance with another aspect of the present invention, the parcel sortation system provides a method for combining the modular interfaces to allow for the sorting of the parcels along the sortation station.

According to another aspect of the present invention, the parcel sortation system provides a controller which reads, monitors and instructs the sorting station whether to sort a parcel.

In accordance with one or more of the above-described aspects, the present invention provides for a parcel sortation system and a method for connecting modular components for sorting parcels. The parcel sortation system may include an induction station, a controller, a sorting station, and an end station. The induction station transports the parcels and provides means to effectively separate the parcels as they are transported, giving them the proper minimum spatial separation, and has at least one modular interface of predetermined modular configuration adapted to be connected with similar modular configurations. The controller gathers information regarding each individual parcel, which can be done while the parcel is transported by the induction station, so that the sortation system can determine the desired parcel destination for each parcel. The sorting station provides a means for sorting the parcels to the desired parcel destinations and is configured to receive the parcels from the induction station and includes at least two modular interfaces which have configurations substantially similar to that of the induction station. Finally, the end station provides a terminating station for the sortation system and is configured to receive the parcels from the sorting station, such that the end station includes at least one modular interface with a configuration substantially similar to the sorting station.

The method for connecting modular components of a parcel sortation system includes the steps of providing an induction station having at least one modular interface of predetermined modular configuration adapted to interconnect with a modular interface of substantially similar configuration, providing a sorting station having at least two modular interfaces with configurations substantially similar to the predetermined modular interface configuration of the induction station, then connecting the induction and sorting stations with the modular interfaces for transporting the parcels from the induction station to the sorting station along a path such that the parcels have a minimum spatial separation between them, then detecting a characteristic of the parcel indicating its desired parcel destination for sorting the parcels along the sorting station in accordance with the detected characteristic, and finally terminating the sorting of the parcels along the sorting station in accordance with the detected characteristic.

The modular interface providing a sorting location for a parcel includes a first sorting module having a leading and trailing end, a second sorting module having a leading and trailing end, a diverter which is integrally operable between the first and second sorting modules, and a transition member which provides an effective connection between the sorting modules to support a parcel as it travels across the sorting modules to be directed to its desired parcel destination by the diverter.

Still other advantages, applications and embodiments of the present invention will become apparent to those skilled in this art from the following description wherein there is shown and/or described several exemplary embodiments of this invention, by way of illustration, for carrying out the invention. As will be realized, the invention is capable of other different aspects, all without departing from the invention. Accordingly, the descriptions and drawings should be regarded as illustrative in nature and not restrictive.

### BRIEF DESCRIPTION OF THE DRAWINGS

While the specification concludes with claims which particularly point out and distinctly claim the present invention, it is believed that the present invention will be better understood from the following description of exemplary embodiments, taken in conjunction with the accompanying drawings, in which like reference numerals identify like elements throughout the views and wherein:

FIG. 1 is a schematic view of the parcel sortation system illustrating an exemplary embodiment of the initial loading point and final sorting destination of parcels as they move through the sortation system;

FIG. 2 is a orthogonal top view of a sorting station illustrating one exemplary embodiment in which the sorting station includes sorting modules configured with modular interfaces;

FIG. 3 is an orthogonal cut-away side view of an exemplary embodiment further illustrating exemplary sorting modules and the mechanisms for transporting and sorting parcels traveling along a sorting station;

FIG. 4 is an enlarged illustration of a section of FIG. 3 depicting an orthogonal side view of the interconnection of substantially similar modular interfaces;

FIG. 5 is an elevational view illustrating an exemplary embodiment of the modularity of the sorting modules;

FIG. 6 is an orthogonal cut-away front view illustrating an exemplary embodiment of the sorting module and the integrally operable diverter;

FIG. 7 is a perspective view depicting an exemplary embodiment of the modular interface having a diverter and transition member; and

FIG. 8 is a block schematic diagram illustrating an exemplary embodiment of the controller operating the sortation system.

### DETAILED DESCRIPTION OF EXEMPLARY EMBODIMENTS OF THE INVENTION

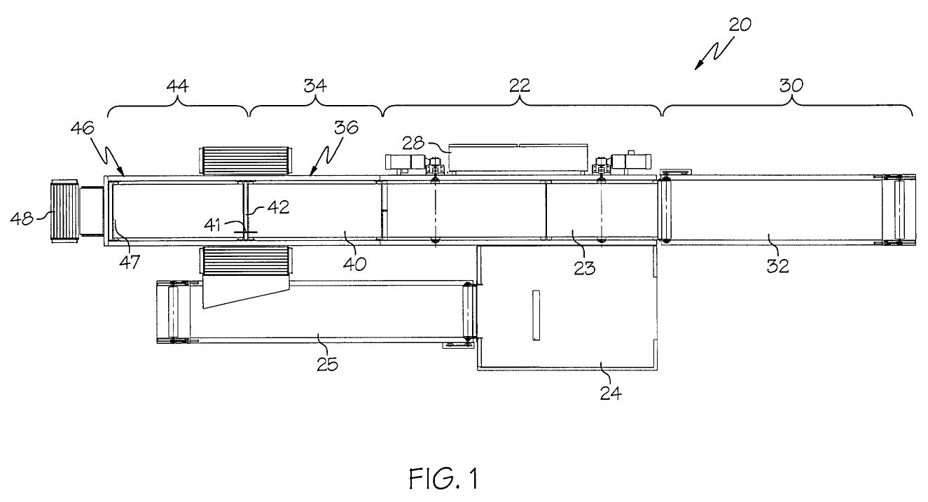

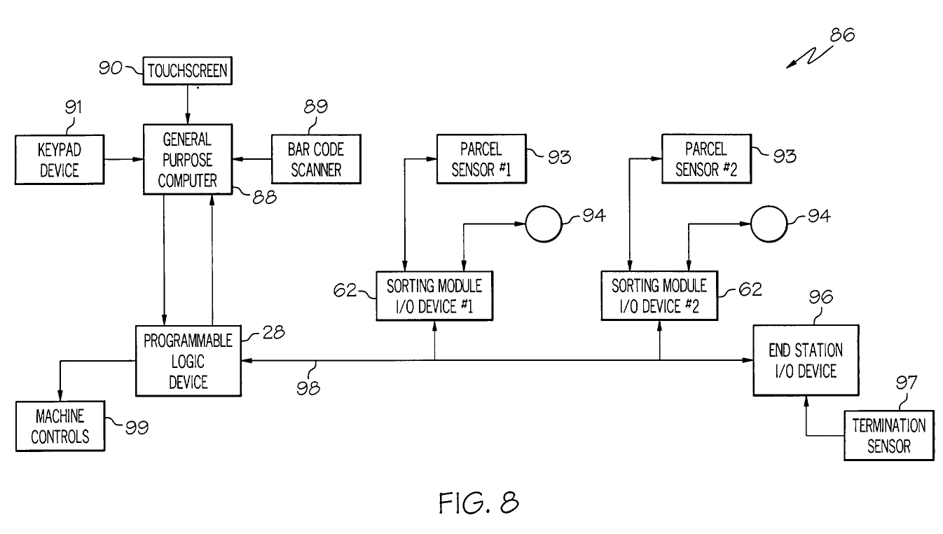

The present invention and its operation are hereinafter described in detail in connection with the views of FIGS. 1-8 illustrating various aspects of exemplary embodiments thereof. Like numbers indicate like elements among the corresponding views. In FIGS. 1-8, a sortation system 20 and method for sorting parcels are illustrated as including an induction station 22 wherein data particular to the parcel regarding its desired parcel destination is received by a controller 86 (see FIG. 8) and communicated by the controller 86 to the sortation system 20, as the parcel continues to a sorting station 34, where the parcel may be sorted as instructed by the controller 86, and if not sorted then is collected at the end station 44, terminating the sorting of the parcel.

FIG. 1 depicts a schematic illustration of an exemplary embodiment of the present invention showing a design layout for a parcel sortation system 20. A parcel as defined in this invention may include boxes, letter carriers, NMO's (non-machinable objects), bags, and a variety of other packages which can include different sizes, shapes, degrees of rigidity, and weights. In particular, these parcels can weigh as much as seventy pounds, which as those skilled in the art will appreciate, is a standard weight limitation in the industry. As illustrated in FIG. 1, a parcel is introduced at a loading station 30, wherein the parcel is moved from the loading station 30 to an induction station 22 so that identifying characteristics associated with the parcel may be detected and inputted to the controller 86 (see FIG. 8) which communicates with the entire sortation system 20. Once the identifying characteristics of the parcel are received, the parcel leaves the induction station 22 and enters a sorting station 34. The sorting station 34 includes at least two modular interfaces, jointly identified in FIG. 1 by the numeral 42, of predetermined modular configuration. Finally, the sorting station 34 terminates at the end station 44 which collects all parcels that are not sorted along the sorting station 34 for delivery to a particular desired parcel destination.

As shown in FIG. 1, the loading station 30 is adjacent to the induction station 22 and could have at least one modular interface 42 having a predetermined modular configuration, or could include a rigid, more permanent support, wherein there is an effective means by which to transfer parcels from the loading station 30 to the induction station 22. A modular interface 42 of the loading station 30 is predetermined so that it can interconnect with a “standardized” modular interface 42, which will allow for a quick, cost-effective, and customizable sortation system 20. By “standardized”, it is meant that the modular interface 42 in the loading station 30 is substantially similar in configuration to the modular interfaces 42 associated with the induction 22, sorting 34 and end stations 44. This “standardized” modular interface 42 provides for the customization sought by users in search of low-cost sorter machines. The loading station 30 can further include a feed conveyor 32 and an alignment member (not shown). The feed conveyor 32 can be driven by a motor, hydraulic cylinder, or a cam mechanism. The feed conveyor 32 can incorporate either a belted or roller design to transport the parcels as they are loaded onto the feed conveyor 32 by either manual or automated means. The belted design tends to provide a smoother transition to the induction station 22, such that the parcels are less disturbed while being transported along the sortation system 20. In an exemplary embodiment which incorporates a belted design, the feed conveyor 32 can be driven at a pace slower than that of the induction conveyor 23 providing the minimum spatial separation needed between each parcel as it is inducted into the induction system. The minimum spatial separation, as defined by this invention, is the spacing that must be maintained in order to permit the sorting system to effectively sort the parcels as they travel along the sorting station 34. For example, the minimum spatial separation for a sortation system of the type illustrated by the exemplary embodiments might be thirty-eight inches. Furthermore, alignment or justification of a parcel prior to entering the induction station 22 can be achieved by the loading station 30, which utilizes the alignment member to effectively justify the parcel as it is transported to the induction station 22 so that it is better positioned to be identified by the sortation system 20. In particular, the alignment member includes, a pair of offset columns configured to center a parcel as it is transported to the induction station 22.

The induction station 22 can serve as the initial point of contact for the parcels, or be configured to receive the parcels from the loading station 30. The induction station 22 includes at least one modular interface 42 of predetermined modular configuration adapted to interconnect with a “standardized” modular configuration. The induction station 22 can further include an induction conveyor 23 and input devices for detecting the identifying characteristics of a parcel. The induction conveyor 23 is driven by at least one means, wherein the at least one means could include a motor, hydraulic cylinder, or cam mechanism. The induction conveyor 23 can include a belted or roller design, however, to provide greater flexibility in regards to the various types of parcels to be sorted on the sortation system 20 as previously described, a belted design will provide greater versatility in transporting the parcels.

As the parcels initially enter the induction station 22, a minimum spatial separation is created between each parcel. The minimum spatial separation can be achieved in numerous ways, including by either manual or automated means. The means for creating the minimum spatial separation can include introducing each consecutive parcel to the induction station 22 at a rate slower than that of the rate by which the initial parcel travels through the induction station 22. For example, this can include having a loading station 30, as previously mentioned, deliver the parcels to the induction station 22 at a speed slower than the speed of the conveyor of the induction station 22, so that when a parcel is introduced to the induction station 22 it is transported at a greater speed, which in turn creates the minimum spatial separation. In the alternative, each parcel could be blocked or paused at the point prior to introduction to the induction station 22 such that the initial parcel would move forward through the induction station 22 creating the minimum spatial separation between parcels. Another option would be to have two induction conveyors 23 along the induction station 22, in parallel, so that the first conveyor is rotated at a higher speed than the second conveyor, thereby creating a minimum spatial separation between the parcels. Finally, the parcels could also be introduced manually, wherein an operator places the parcel into the induction station 22, thus creating the minimum spatial separation.

In addition to creating the minimum spatial separation, the input devices associated with the induction station 22 receives the particular identifying characteristics for each parcel as part of the controller 86 (see FIG. 8), which is operative to receive a communication representative of at least one characteristic, including the desired parcel destination, of a parcel being transported by the induction station 22. The input device can include, but is not limited to, input by a user on a keypad, mouse, touch screen, scanner, PDA, or any other device capable of transmitting data to a general purpose computer 88 as part of the controller 86 of the sortation system 20. In one embodiment, there are a plurality of input devices, wherein the input means can be automated and/or manual. For example, the input devices could include a keypad device 91, touch screen 90 and/or bar code scanner 89. In regards to a bar code scanner 89, it could be positioned adjacent the induction station 22, wherein it could effectively scan the identifying characteristics of each parcel by reading the bar code labels located adjacent a visible portion of the parcel. The bar code scanner 89 can be configured to receive the identifying characteristics from the bar code labels, as long as the bar code label is properly visible, meaning that the bar code cannot be adjacent the underside of the parcel as it tracks through the induction station 22, otherwise it will not be read by the bar code scanner 89. In the event that a parcel cannot be read by the scanner, the induction station 22 could include an operator station 24 having a return chute 25, so that an operator could receive the parcel from the adjacent return chute 25 and manually input the identifying characteristics of the parcel into a general purpose computer 88 and reintroduce the parcel to the sortation system 20. For example, this could be done via the keypad device 91. The controller 86 would be programmed to automatically sort and direct all unread parcels to the return chute 25 to be reentered by the operator, thus enhancing the productivity of this sortation system 20, and providing a check on the system without stopping the other parcels from continuing on through the sortation system 20 to be sorted. It can be appreciated that the bar code scanner 89 would not necessarily be adjacent the induction system, only that it be positioned to read the bar code label at a point prior to the parcel's introduction to the induction station 22. This would allow the bar code scanner 89 to provide the sortation system 20 the opportunity to determine the identifying characteristics of the parcels, prior to entry of the parcels into the sorting station 34.

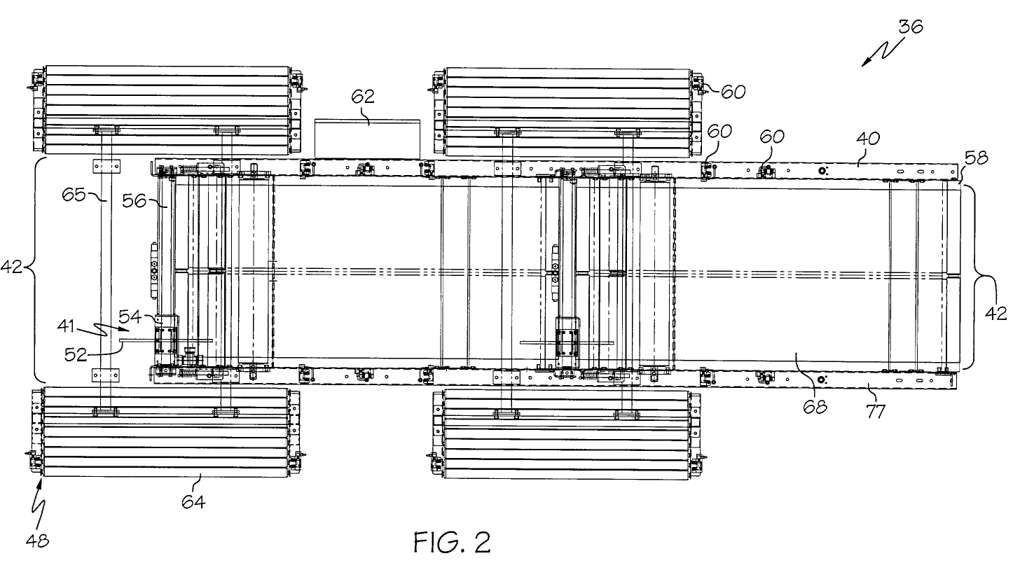

As the parcel leaves the induction station 22 it enters the sorting station 34. The sorting station 34 is configured to receive parcels from the induction station 22 and direct the parcels to the desired parcel destination, wherein the sorting station 34 has at least two modular interfaces 42 that are substantially similar to the predetermined modular interface configuration previously described. The induction station 22 and sorting station 34 are adjacent, such that the sorting station 34 is interconnected to the induction station 22 by one of the at least two “standardized” modular interfaces 42. As further depicted in FIGS. 2-7, the sorting station 34 includes at least one sorting module 36 having at least two “standardized” modular interfaces 42.

Finally, as referenced in the exemplary embodiment of FIG. 1, the end station 44 is configured to receive a parcel from a sorting station 34. The parcels that are designated to the end station 44 have not been properly sorted to their desired parcel destination and must be resorted or manually directed to their desired parcel destination. The end station 44 includes at least one modular interface 42 with a configuration substantially similar to the predetermined modular interface configurations of the sorting station 34, and interconnected to the sorting station 34 by the modular interface 42. The modularity of the end station 44 provides a unique structure, such that the end station 44 serves as a recognition point by the controller 86 that no additional desired parcel destinations exist beyond the end station 44, and therefore the end station 44 serves as the termination point for the sortation system 20. The end station 44 includes an end conveyor 47 and a docking structure (not shown) that further directs the non-sorted parcels to be resorted so that they can be delivered to their desired parcel destinations.

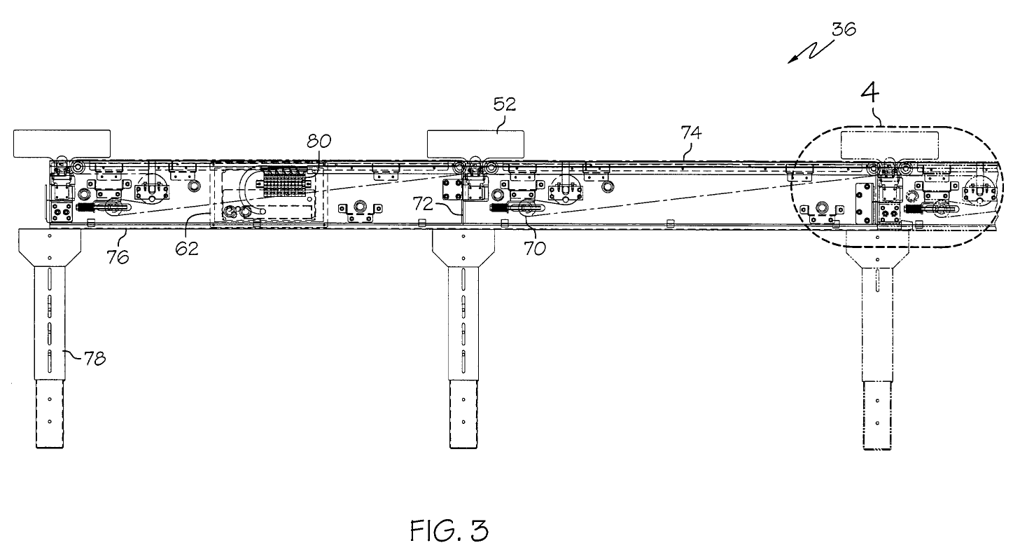

As depicted in FIGS. 2-3, an exemplary embodiment is illustrated by orthogonal top and side views of one form of a sorting module 36, such as one included in the sorting station 34. The sorting module 36 is configured to have at least two modular interfaces 42 having “standardized” modular configurations. As shown here in FIGS. 2-3, the transport direction of the sorting module 36 is substantially linear, however, it can be appreciated by those in the art that adjacent sorting modules 36 can be aligned or linked to form additional shapes including curves, bends, rounded corners, u- and s-shaped designs as more and more sorting modules 36 are connected together such that there is a plurality of sorting modules 36 comprising the sorting station 34. Furthermore, the sorting modules 36 can include various lengths, wherein each module can be pieced together to form a specific layout, allowing the sorting station 34 to sort parcels having various lengths. Additionally, it is envisioned that due to the flexibility introduced by the modular configurations, the sorting station 34 can be designed similar to that of train tracks of a train display, allowing the customer to design a layout which effectively works with a company's current needs and resources.

The specific sorting module 36 shown in FIGS. 2-3 includes two sort conveyors 40 and has a diverter 41 adjacent the end of each sort conveyor 40, which are used to push a parcel from the sort conveyor 40 to a static conveyor 48 which further directs the parcel to the desired parcel destination. In another embodiment of the invention not depicted in the drawings, the sorting module 36 includes one sort conveyor 40 and one diverter 41 or one sort conveyor 40 and multiple diverters 41, wherein multiple desired parcel destinations gather along the sorting module 36.

As further illustrated in FIGS. 2-3, the sorting module 36 includes a base support 78, an upper surface 74, which upper surface 74 includes a sheet of metal having a v-groove (not shown), a bottom surface 76, a belt 68, at least two active rollers 58 to rotate the belt 68 and a means for driving the rollers. The mechanism for driving the rollers could include a motor, hydraulic cylinder, or cam mechanism, wherein the sorting module 36 is self-powered, thereby reducing the need for additional power to be provided by any other section of the sortation system 20, illustrating another advantage of this sortation system 20. The base support 78 is adjacent the bottom surface 76 of the sorting module 36 thereby supporting the sorting module 36 during operation. The bottom surface 76 and upper surface 74 are parallel to one another and are simultaneously supported by vertical members 77 which run perpendicular to the upper and bottom surfaces 76. The sort conveyors 40 are interconnected at the point of sortation along the edge of the vertical member 77, wherein a bracketed joint 72 comprising bolts 73 provides the appropriate structure to keep the sort conveyors 40 joined. The active rollers 58 of the sort conveyor 40 are adjacent the upper surface 74 such that the belt 68, rotated by the active rollers 58, moves substantially parallel with the upper surface 74. The belt 68 travels over the upper surface 74 which is substantially flat to lessen any disturbances that may be felt by the parcel as it is transported down the sorting station 34. The belt 68 wraps around the first and second active rollers 58 and may wrap around a third active roller 58 which serves as a tensioning device 70 to ensure that the belt 68 is properly rotated around the sort conveyor 40 of the sorting module 36 during operation. Attached to the tensioning roller is a tension spring 71 which serves to provide “play” in the tensing roller which gives it flexibility while the belt 68 rotates along the sort conveyor 40.

In another embodiment of the invention, the sortation system 20 has static conveyors 48 positioned to receive and further direct parcels upon having been sorted to their desired parcel destinations or collected at the end station 44 where a parcel fails to be properly sorted. The static conveyors 48, which further direct the parcels, are suspended by the sort conveyor 40 by support bars 66 which perpendicularly traverse the sort conveyor 40. The static conveyors 48 include a plurality of rollers which allow parcels to be collected in bins or stacks so that the parcels are delivered to their desired parcel destinations.

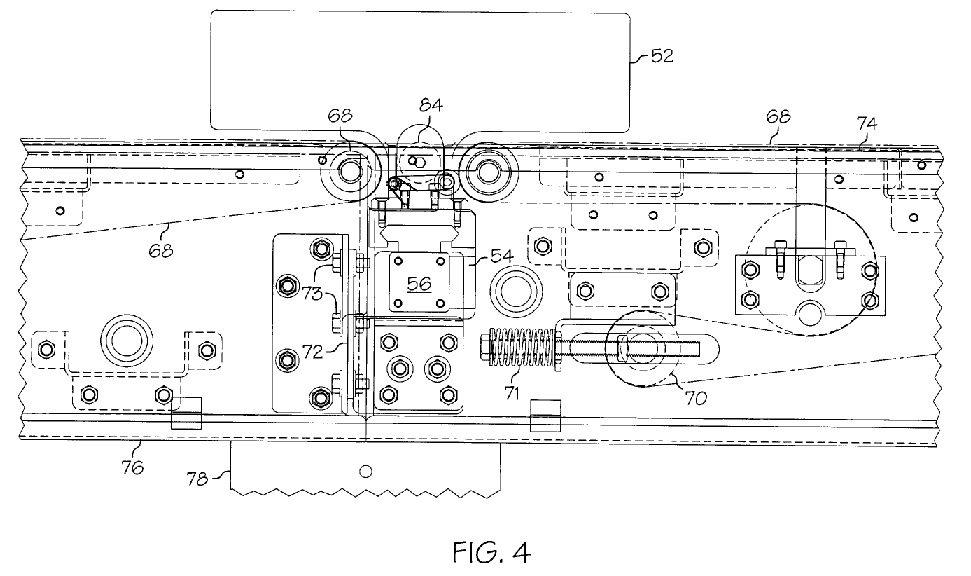

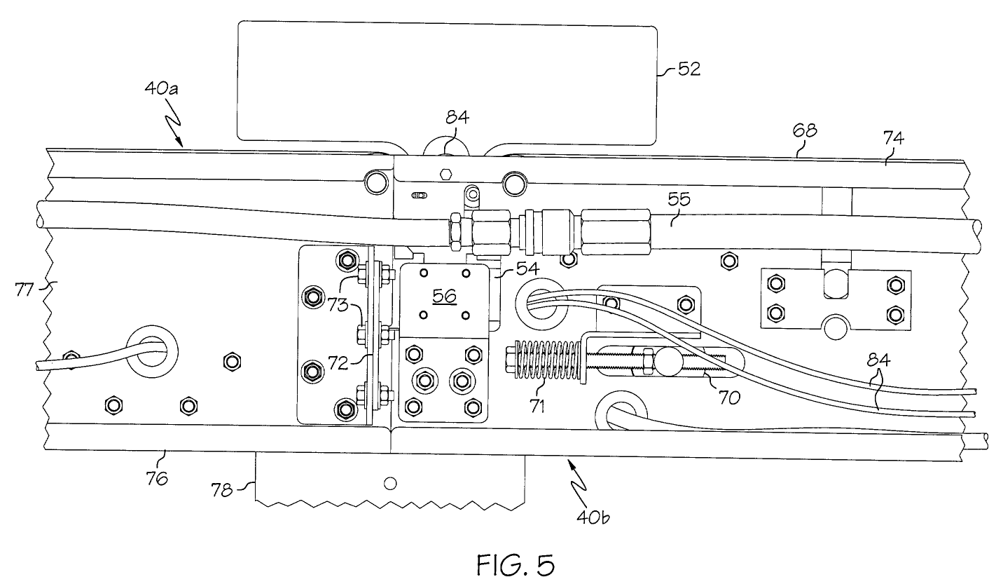

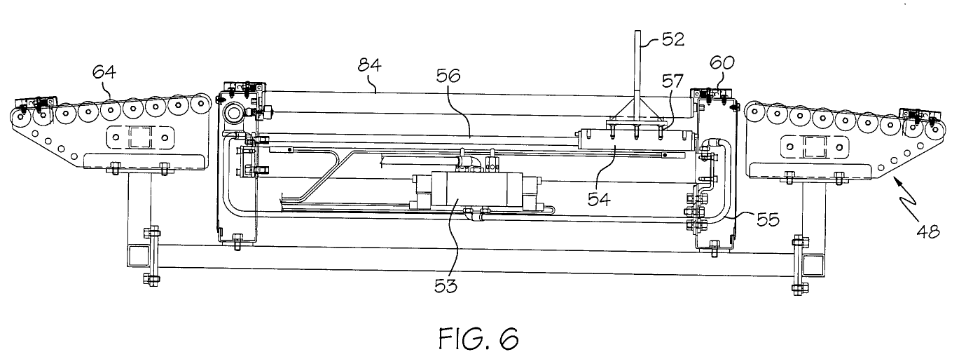

In the exemplary embodiment of FIGS. 4-5, the sorting modules 36 may include modular interfaces 42 having predetermined modular configurations which can easily be interconnected with the modular interfaces 42 of other sorting modules 36 because the modular interfaces 42 have substantially similar predetermined modular configurations, wherein these modular interfaces 42 have “standardized” modular configurations. FIG. 5 depicts one exemplary embodiment illustrating a modular interface 42 comprising first and second sort conveyors 40a,40b, a pneumatic connection 55, network connection 82, and a pair of bracketed joints 72. The pneumatic connection 55 provides a source to drive pneumatic drives 53 (see FIG. 6) and controls associated with the diverter 41. Specifically, the pneumatic connection 55 provides fluid (i.e., air) to the pneumatic controls 94 (see FIG. 8) associated with each sorting module 36. The network connection 82 provides a line of communication from each sorting module 36 through their respective I/O devices 62 to the programmable logic device 28 of the controller 86 overseeing the entire sortation system 20. The bracketed joints 72 provide a mechanical connection between each sorting module 36 providing a solid support in connecting the modular interfaces 42 of each sorting module 36. The bracketed joints 72 employ fastening means, such as bolts 73, to connect the mechanical structures of the “standardized” modular interfaces 42 of a first and second sorting module 36. The first and second conveyors 40a,40b provide substantially flat ends to prevent the sorting modules 36 to more easily attach to one another. The modularity associated with these modular interfaces 42 provides a simple, effective method by which to connect and disconnect components of the sorting station 34. This design provides numerous benefits, mainly it will reduce downtime because a problematic sorting module 36 can easily be removed from the sorting station 34 and replaced having the sortation system 20 back in operation in a short period of time.

FIG. 6 depicts an orthogonal cut-away front view of the sorting module 36, illustrating the integrally operable diverter 41. The diverter 41 includes a paddle 52, slidable member 54 and a stationary member 56 on which the slidable member 54 biases along a substantially linear path. The paddle 52 is attached to the slidable member 54 by fastening means 57, wherein the fastening means 57 include bolts, pins, screws, or any other similar fastening means to attach the paddle 52 to the slidable member 54 such that an effectively rigid attachment is formed. The slidable member 54 can actively be driven along a bi-directional path to allow the attached paddle 52 to sort parcels. The slidable member 54 can be driven by various driving means, including a motor, pneumatic drive 53, hydraulic cylinder, or any other mechanisms that can be understood by one skilled in the art. As illustrated in the exemplary embodiment of FIG. 6, the slidable member 54 is driven by a pneumatic drive 53 which is in communication with the pneumatic and network connections 55,82 such that when the controller 86 instructs the pneumatic drive 53 to position the diverter 41 to the left or right of a parcel to be sorted, the pneumatic connection 55 can provide the appropriate charge to move the diverter 41 at the time and velocity required to direct parcels to their desired parcel destinations.

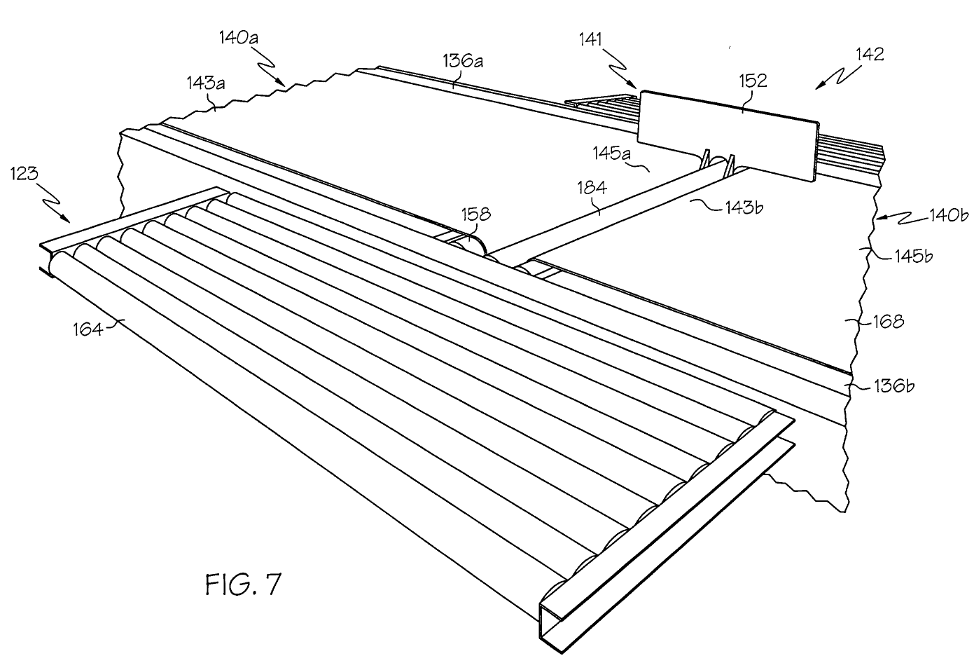

In another embodiment of the invention, as more clearly depicted in the exemplary embodiment of FIG. 7, the modular interface 142 includes a first sorting module 136a having both a leading and trailing end 143a,145a, a second sorting module 136b having both a leading and trailing end 143b,145b, a diverter 141, and a transition member 184. The diverter 141 is intricately formed with a first and second sorting module 136a,136b such that it operates to direct the parcels to their desired parcel destination as the parcel passes from the first sorting module 136a to the second sorting module 136b. The diverter 141 is intricately operable with the sort conveyors 140a, 140b for both sorting modules 136a, 136b. The diverter 141 includes a paddle 152, slidable member (not shown), and stationary member (not shown). The paddle 152 can include any structure which permits it to effectively strike and direct a parcel to its desired parcel destination. The paddle 152 is designed to straddle the transition member 184 so as to not disturb it while the parcel moves from the trailing end 145a of the first sorting module 136a and the leading end 143b of the second sorting module 136b. The slidable member can be driven by numerous mechanisms which may include, for example, a pneumatic drive, motor, or hydraulic cylinder, but as shown in FIG. 7, the slidable member moves along the stationary member powered by a pneumatic drive which is supported by the pneumatic connection 155 along the sorting modules 136a,136b that leads to the air supply on the sortation system 20. The slidable member is operable along a bi-directional path such that the paddle 152 of the diverter 141 can strike a parcel from either side allowing two desired parcel destinations to be associated with one diverter 141. The transition member 184 can include at least one passive roller or a flat member which allows for a smooth transition between sort conveyors 140a,140b. If a transition member 184 is a passive roller, the passive roller is driven by the active rollers on the sort conveyor 140a,140b saving additional costs.

As illustrated in FIG. 8, the controller 86 can include a programmable logic device 28 which can receive, process, and communicate all data necessary to carry out the instructions for sorting the parcels. The controller 86 can further include a general purpose computer 88, which can provide and receive feedback to/from the programmable logic device 28 before, after and while the sortation system 20 is sorting the parcels. The general purpose computer 88 and programmable logic device 28 are in communication via a serial connection 98, such as an Ethernet link. The computer 88 can utilize various operating systems, particularly, it can run Windows, DOS, Linux, Unix, or a variety of other operating systems as can be appreciated by those in the art. Furthermore, the programs on the computer 88 are user-friendly and allow for both off-line and on-line process changes, such as those instructions delivered to the programmable logic device 28 which receives the new instructions and has the machine controls 99 of the sortation system 20 carry them out so that the parcels are sent to the desired parcel destinations. The general purpose computer 88 can receive communications from various input devices, such as the bar code scanner 89, touch screen 90, or keypad device 91, wherein that information is then transmitted to the programmable logic device 28 from the general purpose computer 88. Moreover, the input devices are configured to be user-friendly. For example, the keypad device 91 is capable of tilting along a three-dimensional orientation, making it easier for the operator to manually input data. Furthermore, the input devices, such as the keypad device 91 and touch screen 90, could further be used to adjust the current software program used to sort the parcels by instructing the programmable logic device 28 to make additional changes to the sortation system 20. The programmable logic device 28, which can include a PLC or other logic devices well known by those in the art, communicates with the I/O devices 62 located at each sorting module 36 by way of a network connection 82, wherein the network connection 82 is a serial connection 98, such as Device Net, Profibus, or any other network connection 82 that can be appreciated by one in the art. The I/O devices 62 on each sorting module 36 communicate with the diverter 41 and parcel sensors 93 (i.e., photocells 60) in anticipation of sorting parcels to the desired location and provide feedback information to the programmable logic device 28 on an essentially continuous basis while the sortation system 20 is in operation, in order to accurately sort the parcels.

For example, as a parcel is transported across the sorting station 34 over at least one sorting module 36, a parcel sensor 93, or photocell 60, positioned on each side of the sort conveyor 40 communicates with the I/O device 62 for the sorting module 36 that the leading edge of the parcel has entered an initial sort position. The photocell 60 includes a beam of light that stretches just above the belt 68 of the sort conveyor 40 so that when any size parcel blocks the beam of light, the sortation system 20 recognizes the presence of the parcel. The programmable logic device 28 evaluates this data in relation to the assigned order of the parcel as it travels across the sortation system 20 to determine if the parcel has reached the proper point by which it needs to be directed to its desired parcel destination. If the programmable logic device 28 determines that the parcel needs to be sorted in accordance with its identifying characteristics, the programmable logic device 28 communicates with the I/O device 62 to ready the diverter 41 so that the diverter 41 moves to the appropriate side of the parcel to direct the parcel to the desired parcel destination. Once the trailing edge of the parcel leaves the path of the light beam produced by the photocell 60, the programmable logic device 28 can determine the approximate length of the parcel, calculate the mid-point of the parcel, and inform the diverter 41 to strike the parcel in a location most likely to direct it to the desired parcel destination. Once the parcel is pushed onto a static conveyor 48, an additional pair of photocells 60 are present to ensure first, that the parcel has cleared the path of the sorting conveyor, and second, to ensure that the parcels at a designated desired parcel destination are being promptly collected in a bin or carrier so that the parcels are not backing up on the static conveyor 48, creating blockage disrupting the sortation system 20. If a parcel fails to be sorted, it travels to the end station 44 having an end module 46, and is collected on a static conveyor 48, wherein the programmable logic device 28 recognizes that an end station I/O device 96 associated with the end station 44 is the termination of the sorting process. Furthermore, the end station 44 can include a terminating sensor 97 such that the sortation system 20 realizes that parcels are gathering on the end conveyor 47, which can upset the operation of the sortation system 20.

In another embodiment of this invention, the sortation system 20 further includes a support structure (not shown) which is configured to provide a second tier of sorting. This configuration can be achieved by establishing a second induction station and sorting station approximately above the sortation system 20 as to allow for parcels to be sorted to additional desired parcel destinations. Such a secondary level of sorting potential will provide another level of flexibility and customization, which is the focus and goal of this sortation system 20.

The foregoing description of various embodiments of the present invention has been presented for purposes of illustration and description. It is not intended to be exhaustive or to limit the invention to the forms described. Further modifications are possible in light of the above teachings and would be understood by those of ordinary skill. The embodiments were chosen and described in order to provide examples for illustrating the various principles and adaptability of the invention in various embodiments as are suited to exemplary uses contemplated. Consequently, it is hereby intended that the scope of the present invention is not to be limited to or by the exemplary embodiments shown and/or described herein, but are to be defined by the claims appended hereto.

What is claimed is:

1. A parcel sortation system comprising:
(a) an induction station for transporting parcels having a minimum spatial separation, wherein the induction station comprises at least one modular interface of predetermined modular configuration adapted to interconnect with a modular interface of substantially similar configuration;
(b) a controller, the controller being operative to receive a communication representative of at least one characteristic of a parcel being transported by the induction station, wherein the at least one characteristic includes the desired parcel destination;
(c) a sorting station configured to receive the parcel from the induction station and direct the parcel to the desired parcel destination, wherein the sorting station comprises at least two modular interfaces with configurations substantially similar to the predetermined modular interface configuration, wherein the sorting station is interconnected to the induction station by one of the at least two modular interfaces;
(d) an end station configured to receive the parcel from the sorting station, wherein the end station comprises at least one modular interface with a configuration substantially similar to the predetermined modular interface configuration, wherein the end station is interconnected to the sorting system by one of the at least one modular interfaces.

2. The parcel sortation system according to claim 1, wherein the sorting station comprises at least one sorting module having modular interfaces with configurations substantially similar to the predetermined modular interface configuration.

3. The parcel sortation system according to claim 1, wherein the sorting station comprises a plurality of sorting modules having modular interfaces with configurations substantially similar to the predetermined modular interface configuration.

4. The parcel sortation system according to claim 2, wherein the at least one sorting module comprises at least one sort conveyor and at least one diverter.

5. The parcel sortation system according to claim 4, wherein the at least one sort conveyor and at least one diverter are adjacent.

6. The parcel sortation system according to claim 2, wherein the modular interface comprises communication links, wherein the communication links provide support to sorting modules in sorting the parcels to the desired parcel destinations along the sorting station.

7. The parcel sortation system according to claim 3, wherein the plurality of sorting modules comprise different sizes and lengths.

8. The parcel sortation system according to claim 3, wherein the sorting station comprises a first sorting module and a second sorting module.

9. The parcel sortation system according to claim 8, wherein the module interface further comprises:
(a) a sort conveyor from the first sorting module;
(b) a sort conveyor from the second sorting module
(c) a diverter, wherein the diverter is integrally operable to sort the parcels between the at least one sort conveyor for the first sorting module and at least one sort conveyor for the second sorting module; and
(d) a transition member, wherein the transition member provides an effective connection between the at least one sort conveyor from the first sorting module and the at least one sort conveyor from the second sorting module.

10. The parcel sortation system according to claim 9, wherein the diverter comprises a paddle and a driving mechanism.

11. The parcel sortation system according to claim 9, wherein the diverter is configured to sort the parcels bi-directionally.

12. The parcel sortation system according to claim 9, wherein the transition member comprises a roller, wherein the roller is driven by the sort conveyors for both the first and second sorting modules.

13. The parcel sortation system according to claim 1, wherein the parcel sortation system further comprises a loading station, wherein the loading station is configured to transport the parcel to the induction station.

14. The parcel sortation system according to claim 13, wherein the loading station comprises a feed conveyor and an alignment member.

15. The parcel sortation system according to claim 14, wherein the alignment member effectively justifies the parcel upon transporting the parcels to the induction station.

16. The parcel sortation system according to claim 1, wherein the parcel sortation system further comprises static conveyors to further direct the parcel to the desired parcel destination.

17. The parcel sortation system according to claim 1, wherein the parcel sortation system further comprises a support structure configured to provide a second tier for sorting the parcels.

18. A method for connecting modular components of a parcel sortation system, comprising the steps of:
(a) providing an induction station with at least one modular interface of predetermined modular configuration adapted to interconnect with a modular interface of substantially similar configuration;
(b) providing a sorting station with at least two modular interfaces having configurations substantially similar to the predetermined modular interface configuration of the induction station;
(c) connecting the induction and sorting stations with the modular interfaces;
(d) transporting parcels from the induction station to the sorting station along a predetermined path with minimum spatial separation between the parcels;
(e) detecting a characteristic of the parcel indicative of a desired parcel destination;
(f) sorting the parcels along the sorting station in accordance with the detected characteristic; and
(g) terminating the sorting of the parcels along the sorting station in accordance with the detected characteristic.

19. A method for connecting modular components of a parcel sortation system according to claim 18, wherein the sorting station comprises a plurality of sorting modules.

20. A modular interface providing a sorting location for a parcel, comprising:
(a) a first sorting module having both a leading and trailing end;
(b) a second sorting module having both a leading and trailing end;
(c) a diverter, wherein the diverter is integrally operable to sort the parcel between the trailing end of the first sorting module and the leading end of the second sorting module; and
(d) a transition member, wherein the transition member provides an effective connection between the trailing end of the first sorting module and leading end of the second sorting module.
